(19) United States
(12) Patent Application Publication
(10) Pub. No.: US 2010/0174631 A1
(43) Pub. Date: Jul. 8, 2010

(54) Secure device firmware

(75) Inventors: WeiCheng Tian, ShangHai (CN); Yi Dong, Shanghai (CN)

Correspondence Address: DAVID AND RAYMOND PATENT FIRM, 108 N. YNEZ AVE., SUITE 128, MONTEREY PARK, CA, 91754, US

(73) Assignee: ONBEST TECHNOLOGY HOLDINGS LIMITED

(21) Appl. No.: 12/319,478

(22) Filed: Jan. 7, 2009

(51) Int. Cl. G06Q 40/00

(52) U.S. Cl. 705/35

(57) ABSTRACT

The present invention provides a method and a device using a secure firmware for secure electronic transactions. This firmware realizes two main functions: (1) providing protection for transaction, and (2) providing a unified standard interface for application programs.

### BACKGROUND OF THE PRESENT INVENTION

1. Field of Invention

The present invention relates to a firmware, and more particularly to a firmware of an electronic financial terminal device for secure transaction.

2. Description of Related Arts

With the development of communication and computer technology, more and more financial transactions are performed automatically through electronic terminals and computer system. People are using ATM machines to get cash, using POS machines to pay bills by credit cards, or using internet to manage bank accounts. It is very convenient for the customers or companies to utilize these electronic devices and transmission techniques. But there exists a serious problem. The more convenient it is to perform electronics transaction, the less secure the users' personal information is.

Generally speaking, there are three parties involved in an ordinary transaction activity, the payer, the receiver, and the financial organization. For example, during a purchase deal, the buyer needs to pay money to the seller using a credit card which is operated by a credit card company. At this circumstance, the buyer is the payer, the seller is the receiver, and the credit card company is the financial organization. During the payment activity, the buyer gives his/her credit card to the seller. Then the seller uses seller's POS machine to read/record the information which is stored on the credit card. After that, the seller communicates with the credit card company though the POS machine via a net work to verify the information and request a transaction. After receiving the card information and the request, the credit company then performs the transaction between the accounts of the buyer and the seller respectively.

During the payment activity, the biggest problem is the payer has to provide his credit card information to the receiver. Once this happened, the payer has no control of this information any more. The seller may use this information for criminal purpose intensively, or loss this information to others who may have criminal intention. Another problem is, during the communication between the receiver and the financial organization, data is carried by open net work such as the telephone wire and is possible to be caught for criminal intention.

Currently, as more and more people start to shop online, the problem is more serious because internet is not a secure net work. For an internet transaction, the payer still has to provide his sensitive information to the receiver whom the payer may know nothing about. This is already a big risk. Also, the process of transmitting sensitive information through internet introduces more chances to expose this information to people with criminal intention.

So using traditional method of electronic transaction, there are two fundamental weaknesses. First, the payer has to disclose the sensitive information to the receiver without further control. Second, the transmission of this sensitive information among the payer, the receiver, and the financial organization is not secured. It is necessary to develop a device and a method for performing electronic transaction without disclosing payer's sensitive information to uncontrolled parties, and also with secured transmission method to transmit sensitive information between the payer and the financial organization.

The conventional process of information collection and transmission has many security disadvantages. Firstly, all the data stored in many electronic devices are not well secured. For example, a portable POS machine stored all the credit card information which is only protected by a four-digit password. It is very easy to be decoded through software or hardware. Secondly, many electronic devices are supporting the third party developed software. It is very convenient for the user to expend the device's function. But at the same time, many system resources are also opened to the third party developed software which could access sensitive information for criminal purposes. The best example is virus developed for personal computers. So a new method and a new electronic device for financial application must be developed fully consider the data security.

### SUMMARY OF THE PRESENT INVENTION

The present invention provides a method and a device using a secure firmware for secure electronic transactions. This firmware realizes two main functions: (1) providing protection for transaction, and (2) providing a unified standard interface for application programs.

The present invention is used for electronic financial terminals, which has a very high security request. All the secure related processes, such as secure key management, data encoding and decoding, sensitive data imputing, and sensitive devices operation, must be under control of the firmware. In detail, the secure key/password management manages the working key and the transaction key. The working key comprises verification key for applications, and password for firmware setting. The transaction key comprises encoding key for secure key (KEK), encoding key for data (MACK), encoding key for PIN (PINK), and magnetic stripe card key (MAGK). The data encoding and decoding comprises DES encoding/decoding, and RSA encoding/decoding. The sensitive data inputting includes user's PIN inputting. The sensitive devices operation comprises touch screen operation, LCD display, secrete data accessing, and magnetic reader accessing.

Providing a unified standard interface for application programs is also for the purpose of security. The application programs can only use system call to access the services provided by the firmware, which avoids the direct access to system resources and increases the safety of the system. The firmware provides two main interfaces which are access to the physical devices, and access to sensitive services interface. The physical device interfaces comprise USB related interfaces, serial port, LCD related interface, ICCARD related interface, MAGCARD related interface, DATAFLASH related interface, BEEP related interface, RTC related interface, key board related interface. The sensitive services interface comprises encoding/decoding service, key update service, PIN inputting, and device registration, etc.

An object of the present invention is to provide a secure firmware for the electronic financial terminal devices.

Another object of the present invention is to provide an interface for the electronic financial terminal devices to update software.

Another object of the present invention is to provide a secure interface for the electronic financial terminal devices to be setup safely.

Another object of the present invention is to provide a unified standard interface for the electronic financial terminal devices for secure customer development.

In order to accomplish the above objects, the present invention provides a method for securely operating electronic financial device, comprising the steps of:

(a) storing secrete data in a secure memory wherein application program has not access, wherein said secrete data is always encrypted before being outputted.

(b) providing a supervisor mode wherein a firmware is processed, wherein all system resources are accessible;

(c) providing a user mode wherein user's application program is processed, wherein said application program has no access to system resources; and

(d) providing a unified interface for application program development.

These and other objectives, features, and advantages of the present invention will become apparent from the following detailed description, the accompanying drawings, and the appended claims.

### BRIEF DESCRIPTION OF THE DRAWINGS

FIG. 1 is the flow chart illustrating the process of the application software requesting the firmware for system call.

FIG. 2 is the flow chart illustrating the process of device power on.

FIG. 3 is the flow chart illustrating the process of system booting.

FIG. 4 is the flow chart illustrating the process of the firmware.

FIG. 5 is the flow chart illustrating the process of the firmware update.

FIG. 6 is the flow chart illustrating the process of the application software update.

FIG. 7 is the flow chart illustrating the process of the secure key loading.

### DETAILED DESCRIPTION OF THE PREFERRED EMBODIMENT

The method of secure transaction of the present invention is realized through software and hardware. In a preferred embodiment of the present invention, the device comprises a central processing unit (CPU), the CPU also comprises a static random access memory (SRAM), a secure SRAM, and a memory management unit (MMU) integrated inside. The device also comprises a synchronous dynamic random access memory (SDRAM), and a NorFlash which are connected with the CPU as extend memories. The secure SRAM is used to store the secrete data comprising secure keys, passwords, and other sensitive data. The secure SRAM will not lose the data when the power is off, and will erase the data when the hardware is being attached. The SRAM provides the memory space for the processing of the firmware. Since the SRAM is integrated inside the CPU chip, it will avoid malicious reading by other applications. The extending SDRAM provides the memory space for application software. The NorFlash is used for storing the code of the firmware and the application programs, as well as other data files, such as font and gallery.

The CPU is operating in two modes: the supervisor mode and the user mode. The supervisor mode can access all the resources within the CPU, but the user mode can not access the resources protect by the operation system. The MMU is used to isolate the user space and the firmware space. Through the configuration of the MMU, the application programs processing in the user space can not access the secrete data and resources protected by the firmware. As a result, the secrete data and sensitive services are protected, the transaction is secured.

The MMU realized the memory protection function, and maps the virtual address to the physical address. One important step of the method of the present invention is utilizing the mapping function and access permission function with the MMU in the firmware. The firmware is processing under supervisor mode. The MMU is configured that, in supervisor mode, the entire memory space and resources are accessible; but in user mode, the SRAM in the CPU and the high address space which is the register space of the CPU are not accessible. The high address space of the CPU comprises the secure SRAM space for storing the secure key, passwords, and user's sensitive data. The SRAM is the space for running the firmware.

In this manner, even if the user's application program is modified unfriendly, for example, be hacked, the secure key, passwords, user's sensitive data, and the firmware's code and data are still not able to be read and written by the application program. So the data and the device are secured.

After the firmware actives the function of the MMU, the user's application program is running under user mode. The firmware takes over all the service functions at the bottom-layer, and provides interface functions for the application programs. For example, if the user's application program wants to send data through the serial port, it can not operate the register of the CPU directly because the access to the register is abandoned. The program can only use system call provided by the firmware code to send the data.

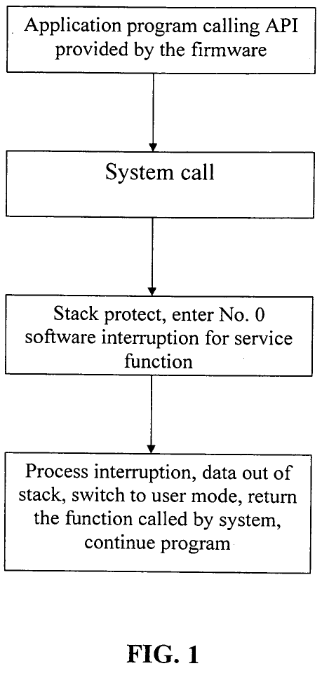

Under user mode, user's application program can not switch the working mode of the CPU, so the application program can not call the bottom-layers service functions directly. FIG. 1 is the process of the application program to access firmware functions via system call, in other words, via software interruptions (SWI).

Referring to FIG. 1, the user application program will provide user different functions, but the realization of the function defends on the firmware. If the operation applied by the application program is not safe, for example, displaying the secure key on screen, but the firm wire doesn't have this function, the application of the function will not be performed. It is obvious the firmware is managing the user's application program safely.

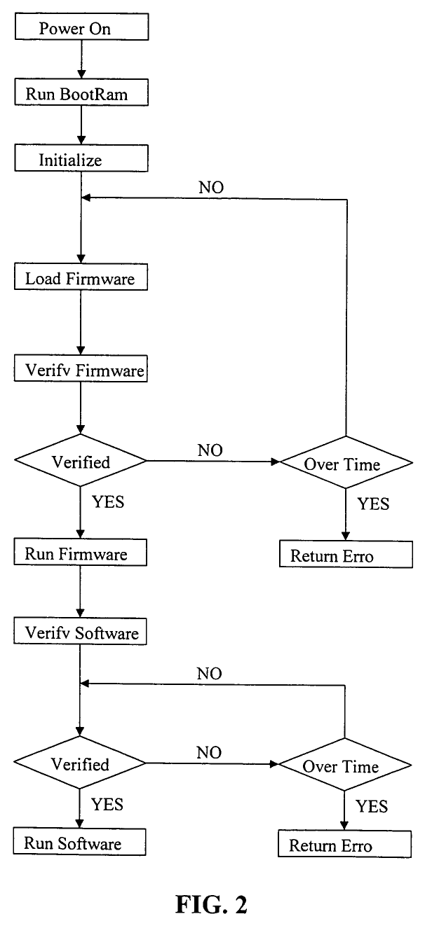

The program of the secure device comprises 4 components: BootRom, Firmware loader, Secure Firmware, and Application Program. Referring to FIG. 2, when the secure device is switched on, the system is powered on, the BootRom which is programmed in the inner ROM of the CPU is processed. The BootRom then locates the Firmware loader in the NorFlash, and loads it into the SRAM within the CPU. After verification, the Firmware loader will be processed if it is verified, other wise it will not be processed and result as system error. The Firmware loader then initializes the registers of the CPU, configures the MMU, then locates the firmware in the NorFlash, and loads the firmware. After the loading of the firmware, the firmware will be verified. If it passes the verification, the firmware will be processed; otherwise, it will turn out to be system error. Once processed, the firmware calls the bottom-layer service functions to initialize the system, then locates the application program code in the NorFlash to load it into the external SDRAM, and verify the application program code. If the application program code is verified, it will be processed, otherwise, it will be system error.

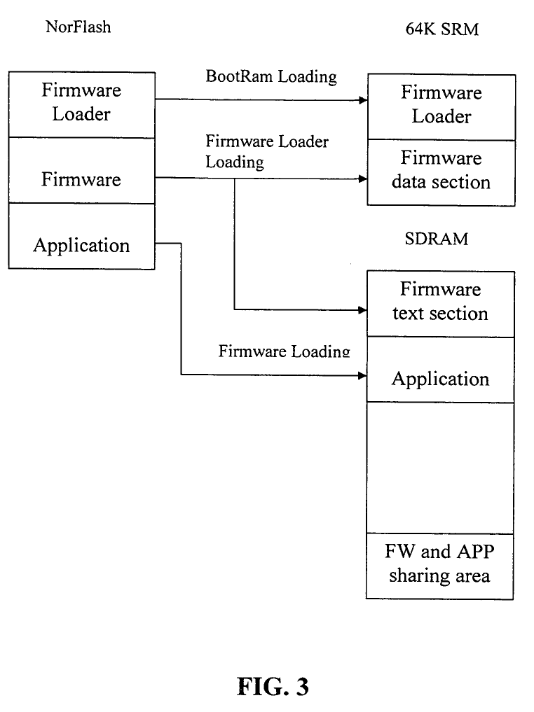

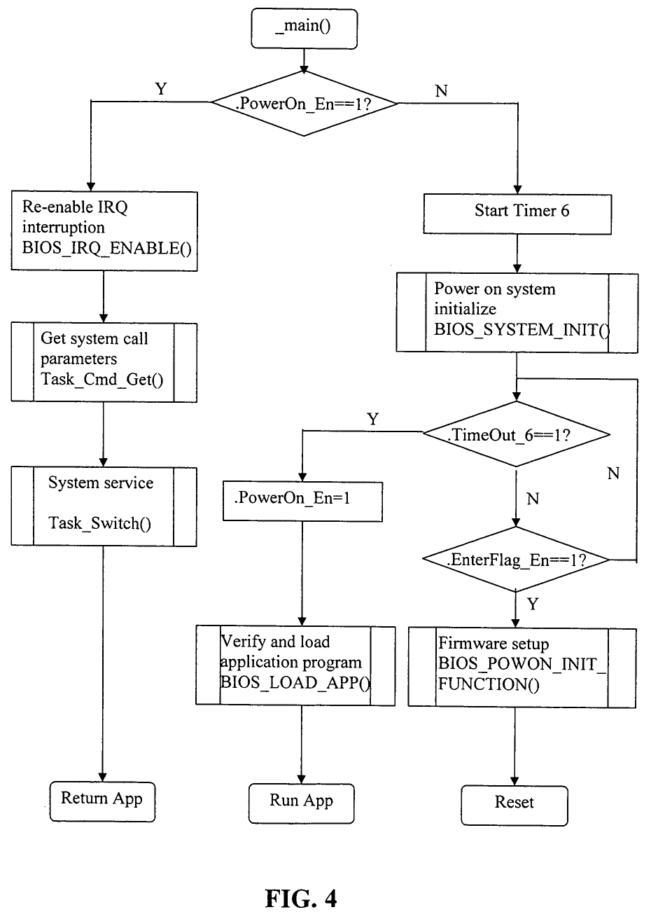

Referring to FIGS. 3 and 4, there are two cases to enter into the firmware space: when every time the system is powered on, and when the software interruption abnormal. Every time when the system is powered on, the device will verify: if it is the first time the device is switched on. If yes, the device will initialize the system password, using a random number generated by a random number generator to generate a secure key. At the same time, some system information and system status are saved.

If it is not the first time powered on, the system will verify if it is needed to set up the firmware. If not, the code of the firmware will verify the necessary fond and gallery, and then process the verification of the application program which is mentioned before.

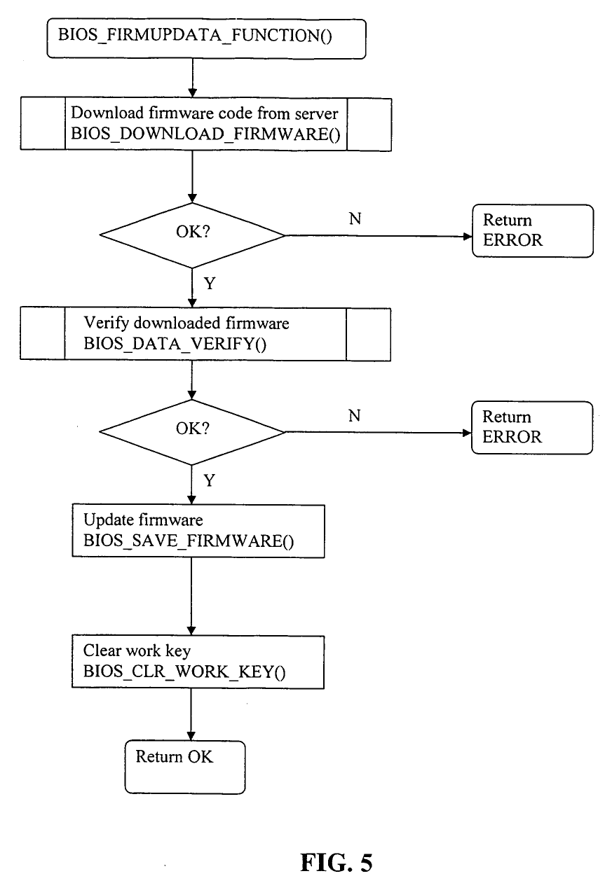

Referring to FIG. 5, if it is needed to reset the firmware, it will enter into the system log in interface, a system password is needed to input. The firmware of the device will send the device information and status to its higher lever server, and wait for the response to verify if it is necessary to enter into hardware update, software update, and secure key loading interface, otherwise it will enter into password and clock setting interface.

If the firmware space is entered because the system is called by the software interruption, the firmware will read the related data from the memory which is shared with the application program, analyze and verify this related data. If the data is verified, the firmware will call the system function in the firmware code. The system function will then call the required bottom-layer services to perform the function. After that, the system will switch back to user mode and return.

Referring to FIG. 5, during firmware update process, when the system is powered on, the user can decide to enter into firmware setup window. If it is selected and the password is verified, the setup window will be entered. The setup window provides two functions: the function of update firmware and application program, loading secure key, and the function of modifying the firmware parameters. For update firmware and application program, the firmware will first send the related information to the server, preferably via USB port. If the server is the setup server and allows the firmware to update, it will send the relative command to the device processing the firmware for update. The firmware will then download the update data to the external SDRAM. After downloading, the firmware will verify the digital signature. If the digital signature is verified, the update will be performed. If the updating is for the firmware, after the updating, the original transaction secure key will be cleared. The setup window provides a device interface to set the firmware password and clock.

The firmware of the present invention provides a unified standard interface for application program development. The application program can only use system call to realize user's applications. This avoids the direct accessing of system resources and increases the security. Also, this interface is dedicated for special utilization, software developed for personal computers can not be processed on this firmware, so the virus for PC can not affect the firmware.

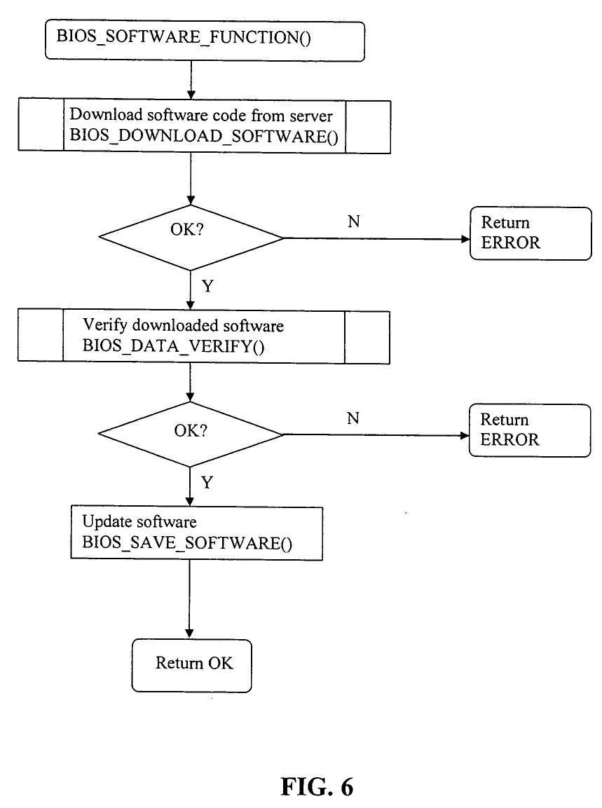

Referring to FIGS. 5 and 6, the updating of firmware and application software is under security control. The code of the firmware or application software must be verified before being installed. So un-authorized program can not run in this system.

For security purpose, the firmware of the present invention set limitation to the application programs. For example, when the user is encoding/decoding data, the application program can only use the encoding/decoding interface provided by the firmware to realize the function, and can not access the secure key data directly. Also, the firmware will never return the secure key data to an application program, it only return the data which is encoded/decoded. For example, the application program must call firmware's interface to ask user to input PIN number. Then the firmware will collect the PIN number and encode the PIN number with a secure key PINK. After that, the firmware will return the encoded number to the application program. The application program will never know the PIN number.

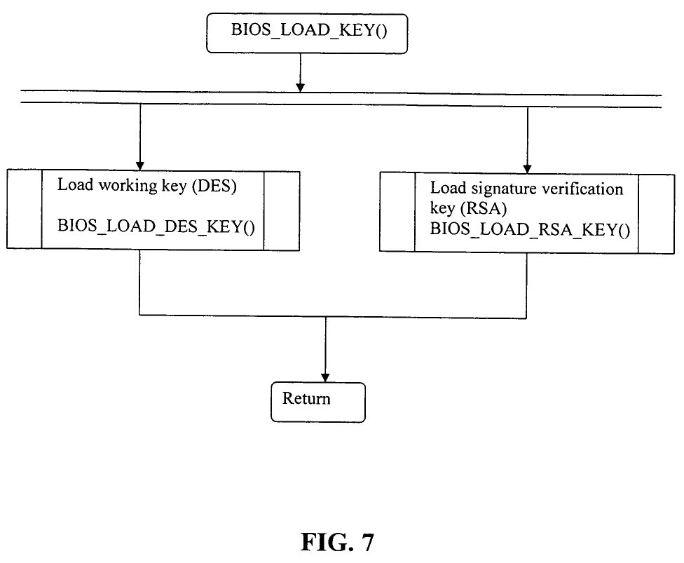

Referring to FIG. 7, the firmware needs load secure keys from the server. The firmware loads public key from the server directly. But the working key is very sensitive, the firmware uses distributed loading method to load working key.

The firmware also limits the application program to input to the LCD. The firmware prohibits the application program to display secrete data, such as PIN, password, on the LCD. All the information displayed needs to be verified by the firmware.

The firmware also limits the application program to call sensitive services in time and frequency. For example, the frequency of the application program to call encoding/decoding service is limited in 10 times per minute.

The firmware also provides a real random input keyboard to avoid the inputted information being detected.

The firmware also provides a debug interface to benefit application software development.

The firmware also provides a file access interface for the application program to access memories such as Flash to increase the efficiency of software development.

The firmware also provides a registration interface for message and user's buffer, to provide communication channel for the application program and the firmware.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for securely operating electronic financial device, comprising the steps of:
(a) storing secrete data in a secure memory wherein application program has not access, wherein said secrete data is always encrypted before being outputted.
(b) providing a supervisor mode wherein a firmware is processed, wherein all system resources are accessible;
(c) providing a user mode wherein user's application program is processed, wherein said application program has no access to system resources; and
(d) providing a unified interface for application program development.

2. The method, as recited in claim 1, further comprises a step of:
(e) managing memory access through mapping virtual memory address to physical memory address, wherein in user mode one or more predetermined memory areas are not accessible.

3. The method, as recited in claim 1, in step (c) wherein said application program has no access to system bottom-layer services, said application program uses system call to request said firmware to perform bottom-layer service functions, wherein if said request is not safe or said firmware does not provide such function, said request will be denied.

4. The method, as recited in claim 2, in step (c) wherein said application program has no access to system bottom-layer services, said application program uses system call to request said firmware to perform bottom-layer service functions, wherein if said request is not safe or said firmware does not provide such function, said request will be denied.

5. The method, as recited in claim 3, in step (c) wherein said application program has no authority to switch working mode from user mode to supervisor mode.

6. The method, as recited in claim 4, in step (c) wherein said application program has no authority to switch working mode from user mode to supervisor mode.

7. The method, as recited in claim 4, wherein further comprises steps of:
(f) verifying downloaded firmware code before firmware updating, wherein if not verified, said code will not be installed; and
(g) verifying downloaded application software before application software updating, wherein if not verified said software will not be installed.

8. The method, as recited in claim 4, wherein further comprises steps of:
(f) verifying downloaded firmware code before firmware updating, wherein if not verified, said code will not be installed; and
(g) verifying downloaded application software before application software updating, wherein if not verified said software will not be installed.
